(19) United States
(12) Patent Application Publication
(10) Pub. No.: US 2003/0012998 A1
(43) Pub. Date: Jan. 16, 2003

(54) Fuel cell installation for driving a vehicle

(76) Inventors: Rolf Bruck, Bergisch Gladbach (DE); Ulrich Gebhardt, Langensendelbach (DE); Joachim Grosse, Erlangen (DE); Jorg-Roman Konieczny, Siegburg (DE); Arno Mattejat, Bubenreuth (DE); Meike Reizig, Bonn (DE); Rittmar Von Helmolt, Mainz (DE)

Correspondence Address: LERNER AND GREENBERG, P.A., Post Office Box 2480, Hollywood, FL, 33022-2480, US

(21) Appl. No.: 10/178,644

(22) Filed: Jun. 24, 2002

Related U.S. Application Data
(63) Continuation of application No. PCT/DE00/04597, filed on Dec. 22, 2000.

(30) Foreign Application Priority Data
Dec. 23, 1999 (DE) 199 62 685.5

(51) Int. Cl. H01M 8/02; B60L 11/18

(52) U.S. Cl. 429/34; 180/65.3

(57) ABSTRACT

The fuel cell installation not only provides the energy for a drive unit of a vehicle, but it is also integrated as a member of the motor vehicle body. The fuel cell system is integrated into the vehicle chassis in such a way that the assembly economizes on components and/or forms a direct load-bearing component of the vehicle chassis.

### CROSS-REFERENCE TO RELATED APPLICATION

This application is a continuation of copending International Application No. PCT/DE00/04597, filed Dec. 22, 2000, which designated the United States and was not published in English.

### BACKGROUND OF THE INVENTION

Field of the Invention

The invention relates to a fuel cell installation which provides the energy for a drive unit of a vehicle. In addition, the invention also relates to the use of this fuel cell installation.

U.S. Pat. No. 5,193,635 describes a motor vehicle which is driven by fuel cells, in which the fuel cell stack is as far as possible protected, for example is arranged centrally on the floor pan, below a seat and/or under the passenger compartment. Additional struts are fitted to the underbody, in order for the stack to be accommodated in a protected assembly inside these struts (“subframe”). A similar configuration is known from European patent EP 0 677 412 B1. There, the motor vehicle underbody forms a supporting structure comprising two frame side members which are at a distance from one another, with the fuel cell installation arranged between the frame side members. Finally, U.S. Pat. No. 5,156,225 describes a motor vehicle with a fuel cell drive in which the entire battery block comprising a plurality of fuel cell stacks is clamped at the end side into in each case one compact, high-mass head part (“bulk head”), the two head parts being connected to the underbody. As a result, the fuel cell stacks are intended to be able to directly absorb external forces.

A drawback of the latter designs is that the additional masses make the underbody or chassis of the vehicle heavier and cause costs.

### SUMMARY OF THE INVENTION

It is accordingly an object of the invention to provide a fuel cell installation for driving a motor vehicle, which overcomes the above-mentioned disadvantages of the heretofore-known devices and methods of this general type and which allow a fuel cell installation with one or more fuel cell stacks to be integrated in an underbody without additional components being required.

With the foregoing and other objects in view there is provided, in accordance with the invention, a fuel cell installation for supplying energy for a drive unit of a motor vehicle, the motor vehicle having an underbody with load-bearing carrier members, the fuel cell installation comprising:

a fuel cell stack formed with at least two fuel cell units and associated supply lines;

the fuel cell stack including at least one structural member selected from the group consisting of a housing, at least one end plate, and an outermost terminal plate;

the fuel cell stack forming an integral part of the underbody of the motor vehicle, whereby the structural member of the fuel cell stack (housing and/or end plate and/or outermost terminal plate) forms a force-bearing component and a part of the load-bearing carrier members of the motor vehicle.

In accordance with an added feature of the invention, the structural member of the fuel cell stack forms a frame side member of the underbody of the vehicle.

In accordance with an additional feature of the invention, the frame side member of the underbody of the vehicle forms an end plate and/or the outermost terminal plate of the fuel cell stack.

In accordance with another feature of the invention, the outermost terminal plate is attached to a frame side member in an electrically insulated manner.

In accordance with a further feature of the invention, the housing of the fuel cell stack is connected in a friction lock (i.e., force lock) to the underbody of the motor vehicle.

In accordance with again an added feature of the invention, the fuel cell stack is one of a plurality of fuel cell stacks each having a height of less than or equal to 200 mm.

With the above and other objects in view there is also provided, in accordance with the invention, a fuel cell installation in a motor vehicle wherein a fuel cell stack of the fuel cell installation is configured and disposed to form a component of an underbody of the motor vehicle.

In accordance with a concomitant feature of the invention, the component is a load-bearing component of the underbody.

In other words, the invention relates to a fuel cell installation as energy carrier for the drive unit of a motor vehicle, comprising at least one fuel cell stack having at least two fuel cell units and supply lines, as well as a housing and/or at least one end plate and/or at least one outermost terminal plate, in which at least one fuel cell stack is part of the underbody.

The novel assembly achieves a considerable cost saving. It is now possible for the load-bearing parts of the motor vehicle, and specifically, in particular, the frame of the underbody, to be used directly in particular for the expensive force-absorbing components of the fuel cell installation which have hitherto been required for fuel cell installations.

Equally, in the invention the housing and/or at least one end plate and/or the outermost terminal plate of the fuel cell stack advantageously performs a load-bearing function on the underbody. For example, according to one embodiment the housing and/or at least one of the end plates and/or the outermost terminal plate replaces a frame side member on the floor pan of the vehicle, where it performs a load-bearing function.

The stack is advantageously no higher than 200 mm. The height of the stack is, for example, the length between the outermost terminal plates or the end plates or a side length of the housing.

The stack advantageously forms a load-bearing component of an underbody, with the stack, for example, being bolted between two members as a force-absorbing strut.

Other features which are considered as characteristic for the invention are set forth in the appended claims.

Although the invention is illustrated and described herein as embodied in a fuel cell installation for driving a vehicle, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 diagrammatically depicts a motor vehicle with an electric drive motor and a fuel cell installation for supplying power to the drive motor, and

FIG. 2 shows a plan view of the underbody of the motor vehicle shown in FIG. 1, with a fuel cell installation integrated in a non-positively locking manner therein.

### DESCRIPTION OF THE PREFERRED EMBODIMENTS

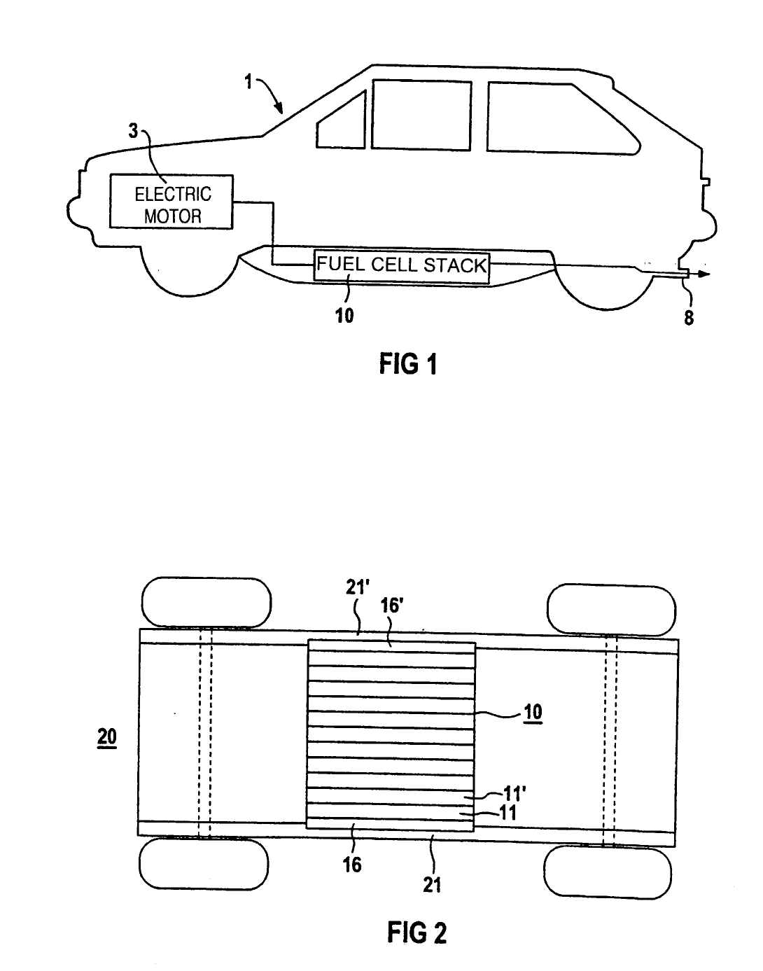

Referring now to the figures of the drawing in detail and first, particularly, to FIG. 1 thereof, there is shown a motor vehicle 1 which, for example, has an electric motor 3 as its drive and a fuel cell installation 10 for supplying energy to the drive. The fuel cell installation 10 may advantageously be a so-called PEM (Proton Exchange Membrane, polymer electrolyte membrane) fuel cell, in particular including an HT fuel cell which operates at temperatures which are higher than normal, in the range from 100 to 300° C. The PEM fuel cell is operated with hydrogen or hydrogen-rich gas which is obtained by reforming from alcohols, such as for example methanol, or alternatively from gasoline, and oxygen, in particular atmospheric oxygen, as oxidizing agent.

For the sake of completeness, the drawing also shows an exhaust 8, in which, during operation with pure hydrogen, product water can escape or, during operation with hydrogen-rich gas, other exhaust gases which are present can escape.

The term fuel cell installation refers to the entire fuel cell system, which comprises one or more subsystems. Each subsystem has at least one fuel cell unit, which comprises corresponding supply lines, i.e. the process-gas feed and discharge passages, end plates and/or a housing and/or an outermost terminal plate, a cooling system with cooling medium and cooling lines. Furthermore, there are “fuel cell stack peripherals”, for example a reformer, compressor, blower and/or heating for process gas preheating, as well as further modules.

The term fuel cell stack, which is also shortened to just stack, is used to refer to at least one fuel cell unit with the associated lines and at least part of the cooling system. The fuel cell stack has a height of less than or equal to 200 mm, so that it can be integrated in the underbody of the motor vehicle. It is preferable for the stack to comprise two or more fuel cell units 11, 11′, . . . connected in series. A stack can be held together by means of two end plates, filter press technology, for example, being used for this purpose, and may be arranged in a housing. The housing is in that case designed to carry pressure and/or to have an insulating action. Finally, the fuel cell units can be joined together in such a way that there is no need for either a housing or end plates in order to form the stack. The outer boundary surfaces of a stack of this type are then the outermost terminal plates or the bipolar plates of the last and first fuel cell units of the stack.

The term fuel cell unit denotes a membrane electrode assembly (MEA) with two terminal plates for receiving current. The MEA is formed in a known way from a membrane with electrodes on both sides, namely a cathode and an anode. Two terminal plates, which if appropriate are formed as bipolar plates, surround the MEA and thus complete the individual fuel cell unit.

With reference to FIG. 2, the motor vehicle 1 has an underbody 20 which substantially comprises a base plate with two frame side members (21, 21′) and cross-beams. In detail, this means that at least one transverse connection is required between the two members 21 and 21′.

In FIG. 2, the transverse connection is formed by the fuel cell stack 10. By way of example, one of the end plates 16 or 16′ of the fuel cell stack 15, which are used to ensure the structure stability during preassembly of the fuel cell stack, is part of the frame side members 21 or 21′. This results in a significant new function as compared to the prior art. While, for example, in European patent EP 0 677 412 B1 the frame side members 21, 21′ are used to mechanically protect the fuel cell unit, the end plates 16 or 16′ of the fuel cell stack 10 now directly form part of the members 21 or 21′.

It is therefore possible for the end plates 16 or 16′ to be designed to be so thin that they do not satisfy the demands imposed on the absorption of forces by means of tie bolts in standard situations, so that the force can be absorbed via the member or other parts of the motor vehicle frame.

It may be sufficient for only one member 21 or 21′ to be rigidly connected to the fuel cell stack. In addition, it is also possible for the separate housing of the fuel cell installation 10, which is not shown in the figures but is normally present, to be part of the underbody. However, it is also possible for the outermost terminal plate of the fuel cell stack to be secured to the underbody, with a suitable electrical insulation between them. In this case, the member of the motor vehicle underbody directly forms the end plate with tie bolts.

In the examples described, the fuel cell installation is integrated in the underbody of the motor vehicle in such a way that this arrangement saves components in that location. It is therefore a direct load-bearing part of the underbody. Secondly, the components of the fuel cell which are usually required in order to absorb forces, such as in particular the end plates, become surplus to requirements, since the underbody of the motor vehicle is used for this purpose.

The dual function of the components results in considerable cost savings over the prior art for a motor vehicle with a drive which is supplied by fuel cells.

We claim:

1. A fuel cell installation for supplying energy for a drive unit of a motor vehicle, the motor vehicle having an underbody with load-bearing carrier members, the fuel cell installation comprising:
a fuel cell stack formed with at least two fuel cell units and associated supply lines;
said fuel cell stack including at least one structural member selected from the group consisting of a housing, at least one end plate, and an outermost terminal plate;
said fuel cell stack forming an integral part of the underbody of the motor vehicle, whereby said structural member of said fuel cell stack forms a force-bearing component and a part of the load-bearing carrier members of the motor vehicle.

2. The fuel cell installation according to claim 1, wherein the structural member of the fuel cell stack forms a frame side member of the underbody of the vehicle.

3. The fuel cell installation according to claim 2, wherein the frame side member of the underbody of the vehicle forms at least one of the end plates and the outermost terminal plate of the fuel cell stack.

4. The fuel cell installation according to claim 3, wherein said outermost terminal plate is attached to a frame side member in an electrically insulated manner.

5. The fuel cell installation according to claim 1, wherein the housing of said fuel cell stack is connected in a friction lock to the underbody of the motor vehicle.

6. The fuel cell installation according to claim 1, wherein said fuel cell stack is one of a plurality of fuel cell stacks each having a height of less than or equal to 200 mm.

7. In combination with a motor vehicle, a fuel cell installation, comprising a fuel cell stack configured and disposed to form a component of an underbody of the motor vehicle.

8. The fuel cell installation according to claim 7, wherein the component is a load-bearing component of the underbody.
